(19) United States
(12) Patent Application Publication
(10) Pub. No.: US 2026/0029160 A1
(43) Pub. Date: Jan. 29, 2026

(54) SOLAR HEATING SYSTEM FOR TANKED ASPHALT

(71) Applicant: Henan Agricultural University, Zhengzhou City (CN)

(72) Inventors: Shengyong Liu, Zhengzhou City (CN); Zhenzhong Wang, Zhengzhou City (CN); Zi'ang Zhen, Zhengzhou City (CN); Lingchen Kong, Zhengzhou City (CN); Rubing Xu, Zhengzhou City (CN); Chunyao Qing, Zhengzhou City (CN); Linzhao Gao, Zhengzhou City (CN); Shixin Li, Zhengzhou City (CN); Lianhao Li, Zhengzhou City (CN); Chunyu Liu, Zhengzhou City (CN); Li Huang, Zhengzhou City (CN); Hongge Tao, Zhengzhou City (CN); Changzhong Ren, Zhengzhou City (CN); Tingting Liu, Zhengzhou City (CN); Feng Suo, Zhengzhou City (CN); Zhuoya Jia, Zhengzhou City (CN); Dengke Zhao, Zhengzhou City (CN); Tengfei Lv, Zhengzhou City (CN); Zhuohui Ma, Zhengzhou City (CN); Zunhan Zhou, Zhengzhou City (CN); Siyu Chen, Zhengzhou City (CN); Yanshen Xu, Zhengzhou City (CN); Jie Lu, Zhengzhou City (CN); Ping Wen, Zhengzhou City (CN); Liying Tian, Zhengzhou City (CN)

(21) Appl. No.: 18/784,459

(22) Filed: Jul. 25, 2024

(51) Int. Cl. F24H 1/20; F24H 1/00; F24H 15/223; F24H 15/25; F24H 15/31; F24H 15/335; F24S 10/40; F24S 23/70; F24S 50/20; F24S 60/30

(52) U.S. Cl. CPC F24H 1/208; F24H 1/0072; F24H 1/202; F24H 15/223; F24H 15/25; F24H 15/31; F24H 15/335; F24S 10/45; F24S 23/70; F24S 50/20; F24S 60/30; F24H 2250/02

(57) ABSTRACT

A solar heating system for tanked asphalt is provided, which belongs to the field of asphalt heating. A solar concentrating collector of the system heats heat transfer oil in a vacuum glass tube by using focused solar energy. The heat transfer oil is transferred to an asphalt heating tank for heating asphalt. Meanwhile, a heat storage tank stores excess heat. The heat storage tank releases heat when solar energy is lacking, and energy may be continuously supplied to the asphalt heating tank by using a heating device in the heat storage tank to heat the asphalt. The solar heating system for tanked asphalt can save fossil energy sources and improve energy use efficiency.

### TECHNICAL FIELD

The present disclosure relates to the field of asphalt heating, and in particular, to a solar heating system for tanked asphalt.

### BACKGROUND

An asphalt mixture on a surface layer of an asphalt pavement needs to be heated when hot repair or hot in-place recycling construction is performed on the asphalt pavement, so that the asphalt mixture is molten and then is harrowed, flattened, and compacted to repair the pavement.

At present, asphalt is mainly heated by using traditional energy sources, which consumes a large amount of fossil fuel and cause serious environmental pollution. Therefore, it is necessary to improve an asphalt heating manner to save fossil energy sources and protect environment.

### SUMMARY

A purpose of the present disclosure is to provide a solar heating system for tanked asphalt, which can save fossil energy sources and improve energy use efficiency.

To achieve the purpose above, the present disclosure provides the following solution:

A solar heating system for tanked asphalt includes a solar concentrating collector, an asphalt heating tank, a heat storage tank, a first inlet valve, a second inlet valve, a first temperature measurement device, a second temperature measurement device, a third temperature measurement device, a heating device, and a control system. An outlet of a vacuum glass tube of the solar concentrating collector is connected to each of an inlet of the asphalt heating tank and an inlet of the heat storage tank, and an inlet of the vacuum glass tube of the solar concentrating collector is connected to each of an outlet of the asphalt heating tank and an outlet of the heat storage tank; the first inlet valve is arranged at the inlet of the asphalt heating tank, and the second inlet valve is arranged at the inlet of the heat storage tank; a measurement end of the heating device is located inside the heat storage tank. The first temperature measurement device, the second temperature measurement device, and the third temperature measurement device are all connected to the control system, and the control system is also connected to the first inlet valve, the second inlet valve, and the heating device. The solar concentrating collector is configured for heating heat transfer oil in the vacuum glass tube by using focused solar energy; the first temperature measurement device is configured to measure temperature of the heat transfer oil at the outlet of the vacuum glass tube; the second temperature measurement device is configured to measure temperature of asphalt in the asphalt heating tank; the third temperature measurement device is configured to measure temperature of the heat transfer oil in the heat storage tank. The control system is configured to open the first inlet valve and close the second inlet valve when the temperature of the heat transfer oil at the outlet of the vacuum glass tube is greater than or equal to a first temperature threshold to enable the heat transfer oil at the outlet of the vacuum glass tube to flow into the asphalt heating tank for heating the asphalt in the asphalt heating tank, and close the first inlet valve and open the second inlet valve when the temperature of the asphalt in the asphalt heating tank is greater than or equal to a second temperature threshold to enable the heat transfer oil at the outlet of the vacuum glass tube to flow into the heat storage tank for storing heat. The control system is further configured to open the first inlet valve and the second inlet valve when the temperature of the heat transfer oil at the outlet of the vacuum glass tube is less than the first temperature threshold and greater than a third temperature threshold to enable the heat transfer oil in the heat storage tank to flow into the asphalt heating tank, and control to turn on the heating device when the temperature of the heat transfer oil in the heat storage tank is less than a fourth temperature threshold to heat the heat transfer oil in the heat storage tank. The control system is further configured to open the first inlet valve and the second inlet valve when the temperature of the heat transfer oil at the outlet of the vacuum glass tube is less than or equal to the third temperature threshold and simultaneously control to turn on the heating device to heat the heat transfer oil in the heat storage tank.

According to specific embodiments provided in the present disclosure, the present disclosure discloses the following technical effects:

In the embodiments, asphalt is heated by solar energy instead of traditional fossil fuel, which saves fossil energy sources. Moreover, excess solar energy is stored by a heat storage tank. Heat in the heat storage tank is released when solar energy is lacking, thereby improving energy use efficiency of a system.

### BRIEF DESCRIPTION OF THE DRAWINGS

FIG. 1 is a schematic structural diagram of a solar heating system for tanked asphalt.

### DETAILED DESCRIPTION OF THE EMBODIMENTS

Technical solutions in embodiments of the present disclosure will be described below with reference to drawings in the embodiments of the present disclosure.

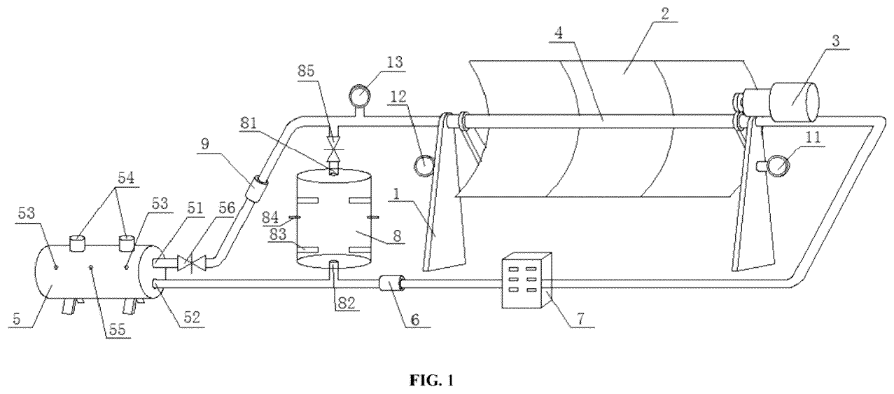

As shown in FIG. 1, a solar heating system for tanked asphalt in this embodiment includes a solar concentrating collector, an asphalt heating tank 5, a heat storage tank 8, a first inlet valve 56, a second inlet valve 85, a first temperature measurement device 13, a second temperature measurement device 53, a third temperature measurement device 84, a heating device, and a control system 7.

An outlet of a vacuum glass tube 4 of the solar concentrating collector is connected to each of an inlet 51 of the asphalt heating tank 5 and an inlet 81 of the heat storage tank 8, and an inlet of the vacuum glass tube 4 of the solar concentrating collector is connected to each of an outlet 52 of the asphalt heating tank 5 and an outlet 82 of the heat storage tank 8. The first inlet valve 56 is arranged at the inlet 51 of the asphalt heating tank 5, and the second inlet valve 85 is arranged at the inlet 81 of the heat storage tank 8. A measurement end of the heating device is located inside the heat storage tank 8.

The first temperature measurement device 13, the second temperature measurement device 53, and the third temperature measurement device 84 are all connected to the control system 7. The control system 7 is also connected to the first inlet valve 56, the second inlet valve 85, and the heating device.

The solar concentrating collector is configured for heating heat transfer oil in the vacuum glass tube 4 by using focused solar energy. Temperature of the heat transfer oil at the outlet of the vacuum glass tube 4 is measured through the first temperature measurement device 13.

Temperature of asphalt in the asphalt heating tank 5 is measured through the second temperature measurement device 53. Temperature of the heat transfer oil in the heat storage tank 8 is measured through the third temperature measurement device 84.

The control system 7 is configured to open the first inlet valve 56 and close the second inlet valve 85 when the temperature of the heat transfer oil at the outlet of the vacuum glass tube 4 is greater than or equal to a first temperature threshold to enable the heat transfer oil at the outlet of the vacuum glass tube 4 to flow into the asphalt heating tank 5 for heating the asphalt in the asphalt heating tank 5, and close the first inlet valve 56 and open the second inlet valve 85 when the temperature of the asphalt in the asphalt heating tank 5 is greater than or equal to a second temperature threshold to enable the heat transfer oil at the outlet of the vacuum glass tube 4 to flow into the heat storage tank 8 for storing heat.

The control system 7 is further configured to open the first inlet valve 56 and the second inlet valve 85 when the temperature of the heat transfer oil at the outlet of the vacuum glass tube 4 is less than the first temperature threshold and greater than a third temperature threshold to enable the heat transfer oil in the heat storage tank 8 to flow into the asphalt heating tank 5, and control to turn on the heating device when the temperature of the heat transfer oil in the heat storage tank 8 is less than a fourth temperature threshold to heat the heat transfer oil in the heat storage tank 8.

The control system 7 is further configured to open the first inlet valve 56 and the second inlet valve 85 when the temperature of the heat transfer oil at the outlet of the vacuum glass tube 4 is less than or equal to the third temperature threshold and simultaneously control to turn on the heating device to heat the heat transfer oil in the heat storage tank 8.

The solar concentrating collector collects heat, and the collected heat heats the heat transfer oil in a pipeline. The heat transfer oil is transferred to the asphalt heating tank 5 through an oil pump to heat the asphalt. Meanwhile, excess heat is stored by the heat storage tank 8. The heat storage tank 8 releases heat when the temperature of the heat transfer oil is too low, so as to ensure continuous heating of the asphalt. When the temperature of the heat storage tank 8 drops to a certain value, an electric heating rod 83 in the heat storage tank 8 is turned on to continuously supply energy to the asphalt heating tank 5, thereby achieving asphalt heating finally.

The system in this embodiment further includes a first pipeline, a second pipeline, a third pipeline, a fourth pipeline, a first oil pump 6, and a second oil pump 9. An end of the first pipeline is connected to the inlet of the vacuum glass tube 4, and the other end of the first pipeline is connected to each of the outlet 52 of the asphalt heating tank 5 and an end of the second pipeline. The other end of the second pipeline is connected to the outlet 82 of the heat storage tank 8. The first oil pump 6 is arranged on the first pipeline. An end of the third pipeline is connected to the outlet of the vacuum glass tube 4, and the other end of the third pipeline is connected to each of the inlet 81 of the heat storage tank 8 and an end of the fourth pipeline. The other end of the fourth pipeline is connected to the inlet 51 of the asphalt heating tank 5. The second oil pump 9 is arranged on the fourth pipeline. The vacuum glass tube 4 receives solar energy, and converts the solar energy into heat energy of the heat transfer oil in the vacuum glass tube 4. The heat transfer oil is transferred to the inlet of the asphalt heating tank 5 through the first oil pump 6 for heating the asphalt, exits from the outlet of the asphalt heating tank 5, and is transferred to the solar concentrating collector for heating. Cycling is achieved through the first oil pump 6.

Refer to FIG. 1, the system further includes an agitator 54. The agitator 54 is arranged on the asphalt heating tank 5. The agitator 54 is connected to the control system 7. The control system 7 is configured to control to turn on the agitator 54 when the temperature of the asphalt in the asphalt heating tank 5 is greater than or equal to a fifth temperature threshold to enable the asphalt in the asphalt heating tank 5 to be heated uniformly.

To achieve automatic tracking of the sun by the solar concentrating collector, the system further includes a photoelectric detector 12. The control system 7 is connected to the photoelectric detector 12 and the solar concentrating collector. The control system 7 receives a solar radiation intensity electrical signal detected by the photoelectric detector 12, and controls the solar concentrating collector to track the sun according to the solar radiation intensity electrical signal.

The system shown in FIG. 1 further includes an aerovane 11, which is mainly configured to analyze a wind direction and a wind speed. The aerovane 11 converts received wind direction and wind speed information into an electrical signal and transmits the electrical signal to the control system 7 to adjust an angle of the concentrating reflector, thereby protecting the concentrating reflector from damage.

The solar concentrating collector includes the vacuum glass tube 4, the concentrating reflector 2, and a driving device 3. The vacuum glass tube 4 is arranged on a focal line of the concentrating reflector 2. The driving device 3 is connected to each of the control system 7 and the concentrating reflector 2. The driving device 3 is configured to drive the concentrating reflector 2 to track the sun under the control of the control system 7 to focus sunlight on the vacuum glass tube 4. The aerovane 11 and the photoelectric detector 12 analyze meteorological conditions before running of the system, convert collected information into electrical signals, and transmit the electrical signals to the control system 7. The control system 7 drives the driving device 3 to adjust the angle of the concentrating reflector 2 to receive solar energy more efficiently.

The vacuum glass tube collects the solar energy, and is filled with the heat transfer oil. The vacuum glass tube 4 is arranged above the concentrating reflector 2, and the concentrating reflector 2 is arc-shaped. The concentrating reflector 2 reflects the sunlight to an absorption line in the vacuum glass tube 4, and a heat-absorbing medium is on the absorption line. A pipe sleeve on an outermost layer of the vacuum glass tube 4 protects the heat-absorbing medium therein. When a solar elevation angle is greater than 10°, the two oil pumps are started. The solar concentrating collector works when receiving an oil pump operating signal and automatically tracks the position of the sun.

To support the entire solar concentrating collector, the system further includes a supporting frame 1. The vacuum glass tube 4 of the solar concentrating collector is arranged on the supporting frame 1.

The system shown in FIG. 1 further includes a liquid level meter 55. The liquid level meter 55 is connected to the control system 7. A height of the asphalt in the asphalt heating tank 5 is measured through the liquid level meter 55. The control system 7 controls the height of the asphalt in the asphalt heating tank 5 according to the height fed back by the liquid level meter 55, so as to prevent overfilling of the asphalt.

The second temperature measurement device 53 includes a first temperature sensor and a second temperature sensor. Both a measurement end of the first temperature sensor and a measurement end of the second temperature sensor are located in the asphalt heating tank 5. Both the first temperature sensor and the second temperature sensor are connected to the control system 7. The control system 7 takes an average value of temperature of the asphalt measured by the first temperature sensor and temperature of the asphalt measured by the second temperature sensor as the temperature of the asphalt in the asphalt heating tank 5. The asphalt heating tank 5 is responsible for heating the asphalt. The heat transfer oil enters through the first inlet valve 56 to indirectly heat the asphalt. Changes of parameters of an asphalt heating process are controlled through the agitator 54, the first temperature sensor, the second temperature sensor, and the liquid level meter 55. Finally, the asphalt flows out of the asphalt heating tank 5 through the outlet 52 of the asphalt heating tank 5.

The third temperature measurement device 84 includes a third temperature sensor and a fourth temperature sensor. Both a measurement end of the third temperature sensor and a measurement end of the fourth temperature sensor are located in the heat storage tank 8. Both the third temperature sensor and the fourth temperature sensor are connected to the control system 7. The control system 7 takes an average value of temperature of the heat transfer oil measured by the third temperature sensor and temperature of the heat transfer oil measured by the fourth temperature sensor as the temperature of the heat transfer oil in the heat storage tank 8.

A loading/unloading port is formed in a bottom of the asphalt heating tank 5, and the loading/unloading port is configured to load or unload the asphalt.

The heat storage tank 8 may be a heat storage tank with an auxiliary heat source. The solar concentrating collector may be a parabolic trough solar concentrating collector.

Exemplarily, the second temperature threshold is 160° C., the fourth temperature threshold is 150° C., and the fifth temperature threshold is 80° C. Then, a working process of the system is as follows:
1. When solar energy is sufficient and excess, the heat transfer oil first heats the asphalt. When the temperature of the asphalt in the asphalt heating tank 5 reaches 80° C., the agitator 54 is turned on to enable the asphalt to be heated uniformly. When the temperature of the asphalt reaches 160° C., the inlet 81 of the heat storage tank 8 is opened, and the inlet 51 of the asphalt heating tank 5 is closed to store excess heat in the heat storage tank 8. The heat transfer oil flows out through the outlet 82 of the heat storage tank 8, and is heated by the solar concentrating collector. Cycling is achieved through the first oil pump 6.
2. When solar energy is insufficient, the solar energy is insufficient to heat the asphalt. The electric heating rod 83 is turned on to heat the heat transfer oil to perform auxiliary energy supply on the asphalt heating tank 5 when the temperature of the heat transfer oil in the heat storage tank 8 is lower than 150° C.
3. When the asphalt needs to be heated at night (without solar energy), the inlet 81 of the heat storage tank 8 and the inlet 51 of the asphalt heating tank 5 are opened simultaneously, the heat transfer oil heats the asphalt cyclically through the second oil pump 9, and the electric heating rod 83 is directly turned on to heat the heat storage tank 8, so that the asphalt is continuously heated at night.

The present disclosure achieves the following advantages:
1. Traditional fossil fuel is replaced for heating the asphalt, which saves fossil energy sources.
2. The heat storage tank 8 stores excess energy, which improves energy use efficiency.
3. Continuous working of a parabolic trough solar asphalt heating system is ensured. When the solar energy is insufficient, the heat of the heat storage tank 8 is released to ensure continuous operation of the system. If the temperature of the heat transfer oil in the heat storage tank 8 drops to a certain temperature, the electric heating rod 83 in the heat storage tank 8 is turned on to provide an auxiliary heat source.

Technical features of the above embodiments may be arbitrarily combined. For the sake of brevity of description, all possible combinations of the technical features in the above embodiments are not described. However, as long as there is no contradiction in the combination of these technical features, it is considered to be a scope recorded in the specification.

Herein, specific examples are used for describing principles and implementations of the present disclosure. The description of the embodiments above is merely intended to help understand the method of the present disclosure and a core idea thereof. In addition, those skilled in the art may make modifications based on the idea of the present disclosure with respect to specific implementations and application scopes. In conclusion, the contents of the present specification shall not be construed as a limitation to the present disclosure.

What is claimed is:

1. A solar heating system for tanked asphalt, comprising a solar concentrating collector, an asphalt heating tank, a heat storage tank, a first inlet valve, a second inlet valve, a first temperature measurement device, a second temperature measurement device, a third temperature measurement device, a heating device, and a control system, wherein
an outlet of a vacuum glass tube of the solar concentrating collector is connected to each of an inlet of the asphalt heating tank and an inlet of the heat storage tank, and an inlet of the vacuum glass tube of the solar concentrating collector is connected to each of an outlet of the asphalt heating tank and an outlet of the heat storage tank; the first inlet valve is arranged at the inlet of the asphalt heating tank, and the second inlet valve is arranged at the inlet of the heat storage tank; a measurement end of the heating device is located inside the heat storage tank;
the first temperature measurement device, the second temperature measurement device, and the third temperature measurement device are all connected to the control system, and the control system is also connected to the first inlet valve, the second inlet valve, and the heating device;
the solar concentrating collector is configured for heating heat transfer oil in the vacuum glass tube by using focused solar energy; the first temperature measurement device is configured to measure temperature of the heat transfer oil at the outlet of the vacuum glass tube; the second temperature measurement device is configured to measure temperature of asphalt in the asphalt heating tank; the third temperature measurement device is configured to measure temperature of the heat transfer oil in the heat storage tank;
the control system is configured to open the first inlet valve and close the second inlet valve when the temperature of the heat transfer oil at the outlet of the vacuum glass tube is greater than or equal to a first temperature threshold to enable the heat transfer oil at the outlet of the vacuum glass tube to flow into the asphalt heating tank for heating the asphalt in the asphalt heating tank, and close the first inlet valve and open the second inlet valve when the temperature of the asphalt in the asphalt heating tank is greater than or equal to a second temperature threshold to enable the heat transfer oil at the outlet of the vacuum glass tube to flow into the heat storage tank for storing heat;
the control system is further configured to open the first inlet valve and the second inlet valve when the temperature of the heat transfer oil at the outlet of the vacuum glass tube is less than the first temperature threshold and greater than a third temperature threshold to enable the heat transfer oil in the heat storage tank to flow into the asphalt heating tank, and control to turn on the heating device when the temperature of the heat transfer oil in the heat storage tank is less than a fourth temperature threshold to heat the heat transfer oil in the heat storage tank; and
the control system is further configured to open the first inlet valve and the second inlet valve when the temperature of the heat transfer oil at the outlet of the vacuum glass tube is less than or equal to the third temperature threshold and simultaneously control to turn on the heating device to heat the heat transfer oil in the heat storage tank.

2. The solar heating system for tanked asphalt according to claim 1, further comprising a first pipeline, a second pipeline, a third pipeline, a fourth pipeline, a first oil pump, and a second oil pump, wherein
an end of the first pipeline is connected to the inlet of the vacuum glass tube, and an other end of the first pipeline is connected to each of the outlet of the asphalt heating tank and an end of the second pipeline; an other end of the second pipeline is connected to the outlet of the heat storage tank; the first oil pump is arranged on the first pipeline;
an end of the third pipeline is connected to the outlet of the vacuum glass tube, and an other end of the third pipeline is connected to each of the inlet of the heat storage tank and an end of the fourth pipeline; an other end of the fourth pipeline is connected to the inlet of the asphalt heating tank; and the second oil pump is arranged on the fourth pipeline.

3. The solar heating system for tanked asphalt according to claim 1, further comprising: an agitator, wherein
the agitator is arranged on the asphalt heating tank;
the agitator is connected to the control system; and the control system is configured to control to turn on the agitator when the temperature of the asphalt in the asphalt heating tank is greater than or equal to a fifth temperature threshold to enable the asphalt in the asphalt heating tank to be heated uniformly.

4. The solar heating system for tanked asphalt according to claim 1, further comprising: a photoelectric detector, wherein
the photoelectric detector is connected to the control system, and the control system is also connected to the solar concentrating collector; and
the control system is configured to receive a solar radiation intensity electrical signal detected by the photoelectric detector, and control the solar concentrating collector to track the sun according to the solar radiation intensity electrical signal.

5. The solar heating system for tanked asphalt according to claim 1, wherein the solar concentrating collector comprises: the vacuum glass tube, a concentrating reflector, and a driving device;
the vacuum glass tube is arranged on a focal line of the concentrating reflector;
the driving device is connected to each of the control system and the concentrating reflector; and
the driving device is configured to drive the concentrating reflector to track the sun under the control of the control system to focus sunlight on the vacuum glass tube.

6. The solar heating system for tanked asphalt according to claim 1, further comprising: a supporting frame, wherein
the vacuum glass tube of the solar concentrating collector is arranged on the supporting frame.

7. The solar heating system for tanked asphalt according to claim 1, further comprising: a liquid level meter, wherein
the liquid level meter is connected to the control system; and
the liquid level meter is configured to measure a height of the asphalt in the asphalt heating tank and transmit the height to the control system.

8. The solar heating system for tanked asphalt according to claim 1, wherein the second temperature measurement device comprises: a first temperature sensor and a second temperature sensor;
both a measurement end of the first temperature sensor and a measurement end of the second temperature sensor are located in the asphalt heating tank;
both the first temperature sensor and the second temperature sensor are connected to the control system; and
the control system is configured to take an average value of temperature of the asphalt measured by the first temperature sensor and temperature of the asphalt measured by the second temperature sensor as the temperature of the asphalt in the asphalt heating tank.

9. The solar heating system for tanked asphalt according to claim 1, wherein the third temperature measurement device comprises: a third temperature sensor and a fourth temperature sensor;
both a measurement end of the third temperature sensor and a measurement end of the fourth temperature sensor are located in the heat storage tank;
both the third temperature sensor and the fourth temperature sensor are connected to the control system; and
the control system is configured to take an average value of temperature of the heat transfer oil measured by the third temperature sensor and temperature of the heat transfer oil measured by the fourth temperature sensor as the temperature of the heat transfer oil in the heat storage tank.

10. The solar heating system for tanked asphalt according to claim 1, wherein a loading/unloading port is formed in a bottom of the asphalt heating tank, and the loading/unloading port is configured to load or unload the asphalt.
